(19) United States
(12) Patent Application Publication
(10) Pub. No.: US 2025/0375784 A1
(43) Pub. Date: Dec. 11, 2025

(54) A LOCKING MECHANISM, A DISPENSING PUMP ASSEMBLY, A CONTAINER SYSTEM AND A METHOD FOR USING THE SAME

(71) Applicant: SILGAN DISPENSING SYSTEMS (WUXI) CO. LTD., RICHMOND, VA (US)

(72) Inventors: Xi Li, WUXI (CN); Li Zhang, WUXI (CN); Linxing MAO, WUXI (CN)

(73) Assignee: SILGAN DISPENSING SYSTEMS (WUXI) CO. LTD., RICHMOND, VA (US)

(21) Appl. No.: 18/877,008

(22) PCT Filed: Jun. 21, 2023
(86) PCT No.: PCT/CN2023/101565

§ 371 Date: Dec. 19, 2024

(30) Foreign Application Priority Data
Jun. 23, 2022 (CN) 202210717594.2

(51) Int. Cl. B05B 11/10

(52) U.S. Cl. CPC B05B 11/1059

(57) ABSTRACT

The present invention relates to a locking mechanism, a dispensing pump assembly, a container system and a method for using the same. A locking mechanism for a dispensing pump comprises: a movable button actuatable by a user to move between an initial position and a pressed position; a slidable switch embedded in the button, being actuatable by the user to move between an open position and a close position, such that the locking mechanism changes between an unlocking state and a locking state; and a rotatable annular member cooperating with the switch, which can be actuated by the switch such that a sliding movement of the switch causes rotation of the annular member, wherein: when the locking mechanism is in the unlocking state, the annular member allows the user to actuate the button so as to enable a dispensing; and when the locking mechanism is in the locking state, the annular member prevents the movement of the button so as to prohibit the dispensing.

### TECHNICAL FIELD

The present invention generally relates to a locking mechanism for a dispensing pump, a dispensing pump assembly comprising the locking mechanism, and a container system for dispensing a material. Further, the present invention relates to a method of using such locking mechanism, a dispensing pump assembly and a container system.

### BACKGROUND

Nowadays, dispensing pump devices for various liquids, emulsions, foams, gels, etc. are common in daily life. Such dispensing pump devices are typically provided with a reciprocating piston-type dispensing pump for pumping and dispensing the products in the container. These reciprocating piston-type dispensing pumps are actuated by pressing down the dispenser head so as to enable the dispending of the product through a nozzle above or in the dispenser head. When the dispenser head is released, an internal spring moves the head up back to its initial position. During the transport of these dispensing pump devices, the dispenser head is usually locked in a fixed position to prevent its reciprocating movement and thus to avoid product leakage. Simple designs involve providing a shroud or an outer cover outside the dispensing pump device, which is engaged for example by threads. For such designs, the user must unscrew the outer cover, or even having to remove it by both hands at the same time. Obviously, such cumbersome operations would greatly degrade the user experience and feeling.

In some designs, the locking feature involves rotating the dispenser head backward (or forward) for a small angle (e.g., less than 90 degrees) in order to bring the head into a locked position not allowing for an axial movement, or bring the head into an unlocked position enabling an axial movement and thus the product being able to be dispensed. Such locking features are often irreversible, i.e. once the user moves them from the locking position to the unlocking position, they can never return back to its locking position, such as the designs frequently used for containers of products such as shampoo, conditioner and shower gel.

Other designs include a pushable locking member outside the piston rod of the dispenser head. The locking member has respectively a large diameter larger than the piston rod diameter and a small diameter smaller than the piston rod diameter on both sides, which is pushed to the larger diameter to allow for the dispensing and the dispensing is prevented by its movement in the reverse direction. Yet other designs include providing a releaseable locking member outside the piston rod, such as a tearable strip. When such locking members are released, the piston rod is allowed to move. Such designs require providing additional components outside the dispensing pump device, which greatly limits the overall aesthetic design of the dispensing pump device. Moreover, such designs are only suitable for dispensing pump devices with a piston rod exposed to the ambient, and are not suitable for products with relatively high requirements for air tightness. The piston rod for such products is usually sealed inside the dispensing pump device to ensure isolation from the air.

The air tightness of the container cannot be fully ensured by existing locking designs, and the leakage of the product cannot be completely prevented, especially during for example the transport or the travel, due to shaking or accidental dropping or pressing, there would still be product spillage from the container opening or from the nozzle, resulting in being disadvantageous for transport, and leading to a poor customer experience.

Moreover, the existing designs are only suitable for dispensing pump devices with a circular or arcuate outer contour. For dispenser devices with a rectangular outer contour, the existing designs cannot provide a solution that allows locking such dispenser devices, since a rotational movement is not available with the rectangular shape.

### SUMMARY OF THE INVENTION

The present invention aims at solving the problems in the prior art as mentioned above, and providing a locking mechanism that the user can operate repeatedly with a simple construction, which fully ensures the air tightness and allows to be suitable for dispenser devices with a rectangular outer contour. Such locking mechanisms also allow improving the overall aesthetic appearance of the container system which is highly attractive.

According to one aspect of the present invention, a locking mechanism for a dispensing pump is provided, comprising:
a movable button actuatable by a user to move between an initial position and a pressed position;
a slidable switch embedded in the button, the switch being actuatable by the user to move between an open position and a close position, such that the locking mechanism changes between an unlocking state and a locking state;
a rotatable annular member cooperating with the switch, which can be actuated by the switch such that a sliding movement of the switch causes rotation of the annular member, wherein:
when the locking mechanism is in the unlocking state, the annular member allows the user to actuate the button so as to enable a dispensing; and when the locking mechanism is in the locking state, the annular member prevents the movement of the button so as to prohibit the dispensing.

In one embodiment of the present invention, the locking mechanism further comprises an actuator located below the button for actuating the dispensing pump, the actuator being connected with the button and actuated by the button, wherein the actuator comprises at least one guiding post, at least a portion of which is received in a corresponding guiding groove of the annular member, and the guiding post is movable between a first end and a second end of the guiding groove relative to the annular member.

In one embodiment of the present invention, when the locking mechanism is in the locking state, the guiding post is located at the first end of the guiding groove which prevents the guiding post from moving down; and when the locking mechanism is in the unlocking state, the guiding post is located at the second end of the guiding groove which allows the guiding post to move down.

In one embodiment of the present invention, the first end of the guiding groove comprises a barrier at the bottom to prevent the guiding post from moving down, and the second end of the guiding groove is open at the bottom to allow the guiding post to move down.

In one embodiment of the present invention, the actuator comprises a first guiding post and a second guiding post: the annular member comprises a first guiding groove and a second guiding groove respectively receiving the first guiding post and the second guiding post: when the annular member is actuated, the first guiding post and the second guiding post move in the same direction with respect to the annular member.

In one embodiment of the present invention, the first end and the second end of the first guiding groove are disposed to be centrally symmetrical with the first end and the second end of the second guiding groove.

In one embodiment of the present invention, the switch comprises:
a base;
a slider extending outward from the base; and
an engaging portion located on the inside of the base, which is configured to engage with the annular member so as to actuate the annular member.

In one embodiment of the present invention, the switch further comprises an extension portion extending inward from the engaging portion, and when the switch is in an intermediate position, the extension portion is configured to extend inward and slightly exceed an outer end of a tab of the actuator, such that when the extension portion passes the tab upon sliding the switch, it rubs slightly against the tab, thereby producing a crisp sound and/or providing the user with a tactile prompt that a switchover has been implemented.

In one embodiment of the present invention, the switch is located on only one side of the locking mechanism.

In one embodiment of the present invention, the annular member comprises: a central through-opening, through which the dispensing pump passes:
at least one lateral flange configured to limit the stroke of the annular member; and
a receiving portion configured to receive the engaging portion of the switch and to cooperate with it, such that a sliding motion of the switch is converted into a rotational motion of the annular member.

In one embodiment of the present invention, the button further comprises: a top lid:
a first fastener configured to fix the button to an outer cover;
a second fastener configured to fix the button to the actuator;
a sidewall comprising a window enabling the switch to be visible to the user and through which the slider of the switch extends such that the slider is accessible to the user;
a limit stop configured to limit the open position and the close position of the switch;
and/or
a stroke guide for guiding the movement of the switch such that the switch moves along a predetermined travel path.

In one embodiment of the present invention, the actuator further comprises: a central channel for receiving the dispensing pump, inside of which comprises a connector in fluid communication with the dispensing pump; and a lateral channel for receiving a nozzle so that when the actuator moves down, so as to enable the dispensing by means of the dispensing pump via the nozzle.

In one embodiment of the present invention, the locking mechanism further comprises an outer cover which receives the button on the inside and allows the button to move down, the outer cover further comprising a nozzle guiding channel for receiving and guiding the movement of the nozzle.

In one embodiment of the present invention, an outer surface of the switch and/or the button do not exceed an outer surface of the outer cover.

In one embodiment of the present invention, the outer cover and/or the button have a rectangular outer contour.

According to another aspect of the present invention, a dispensing pump assembly is provided, comprising:
the locking mechanism as described above;
a nozzle for dispensing a material;
a dispensing pump for pumping the material, which is connected to the actuator; and
a collar connected with the dispensing pump and located outside of the dispensing pump, which is also connected to the outer cover and the container, and the collar further comprises at least one lateral opening which limits the stroke of the lateral flange of the annular member.

According to yet another aspect of the present invention, a container system is further provided, comprising:
the dispensing pump assembly as described above;
a tube connected with a lower end of the dispensing pump; and
a container which defines a storage chamber for containing a material, the container being hermetically connected with the dispensing pump assembly at the top circumference, wherein the tube extends into the container, and when the switch is at the open position, pressing the button allows the material to be dispensed from the container.

In one embodiment of the present invention, the container has a rectangular outer contour.

The present invention further relates to a method for using the container system described above, comprising:
sliding the switch from a close position to an open position such that the locking mechanism switches from a locking state to an unlocking state, and at the same time, the guiding post of the actuator moves from the first end of the guiding groove to the second end relative to the annular member;
pressing the button to move it down from an initial position to a pressed position such that the actuator is caused to actuate the dispensing pump to dispense the material from the container via the nozzle.

In one embodiment of the present invention, when an intermediate position is passed by upon sliding the switch, the extension portion of the switch passes by and slightly rubs against the tab of the actuator, thereby producing a crisp sound and/or providing the user with a tactile prompt that a switchover has been implemented.

By means of the locking mechanism in the present application, the linear sliding motion of the switch may be converted into a rotational motion of the annular member located inside, whereby easily switching the locking mechanism between the locking state and the unlocking state. The switch according to the present invention may be designed to be very small in size. A user can even implement the switchover operation by toggling the switch with a single finger. Compared with the existing designs, the tedious operation of removing the outer cover by the user can be omitted. Moreover, the switch is recessed inward into the button, which avoids the situation of product leakage caused by accidental opening of the switch.

Further, the switch and the button as a whole do not protrude beyond the outer cover, so that the dispensing pump assembly and even the container system as a whole do not have an obviously protruding part or contour, thereby improving the compactness of the entire system and saving space. A container system having a locking mechanism according to the present invention may generally have a parallelepiped shape, such as a square profile, thereby providing a pleasing, distinctive and integrated aesthetic appearance.

By means of the cooperation between the guiding groove of the annular member and the guiding post of the actuator according to the present invention, a very secure locking can be provided. When the switch is at the close position, even if the container system falls or collides and the like, leading to that the button is pressed, since the downward movement of the guiding post is blocked by the annular member, the pump core would always be in a closed state, so that the product in the container system would not leak, which greatly improves the tightness as well as the protection during transport or use. In addition, by providing two or more pairs of guiding posts and guiding grooves, a multi-point support for the actuator and button can be formed, further reinforcing the locking. Moreover, in the locking state, the guiding post and guiding groove are provided at the intermediate position, and product leakage would not occur even if the corner of the button is pressed continuously.

In the unlocking state, when the user presses the button, the guiding post helps to guide the button and actuator to move down, ensuring that the button and actuator move in the vertical direction, so that the pump core can provide a stable dispensing amount, and at the same time the user is provided with a better pressing feel.

During the switchover between the open position and the close position, the cooperation between the extension portion on the switch and the tab on the actuator allows the user to have a clear feel such as a gear-shift hand feel and/or hear a clear sound as a prompt on the switchover, greatly improving the user experience.

Other forms, objectives, features, aspects, advantages, and other embodiments of the present invention will be apparent from the detailed description and drawings provided herein.

### BRIEF DESCRIPTION OF THE DRAWINGS

The disclosure of the present invention will be more clear with reference to the drawings. It should be understood that these drawings are only for illustrative purposes, and are not intended to limit the protection scope of the present invention. In the drawings,

FIG. 1a and FIG. 1b are general schematic views of a container system according to one embodiment of the present application.

FIG. 2 is an exploded schematic view of the container system according to one embodiment of the present application as shown in FIGS. 1a and 1b.

FIG. 3a and FIG. 3b are general schematic views of a button according to one embodiment of the present application.

FIG. 4a and FIG. 4b are general schematic views of a switch according to one embodiment of the present application.

FIG. 5a and FIG. 5b are general schematic views of an annular member according to one embodiment of the present application.

FIG. 6a and FIG. 6b are general schematic views of an actuator according to one embodiment of the present application.

FIG. 7a and FIG. 7b schematically show the switch that has been assembled into the button.

FIG. 8 schematically shows the annular member that has been assembled into the collar.

FIG. 9a, FIG. 9b and FIG. 9c schematically show the cooperation between the switch and the annular member, wherein FIG. 9a shows the switch at the close position, FIG. 9b shows the switch at the intermediate position, and FIG. 9c shows the switch at the open position.

FIG. 10a, FIG. 10b and FIG. 10c schematically show the actuator, the switch and the annular member already assembled, wherein FIG. 10a shows the switch at the close position, FIG. 10b shows the switch at the intermediate position, and FIG. 10c shows the switch at the open position.

FIG. 11a and FIG. 11b schematically show the cooperation between the guiding post of the actuator and the guiding groove of the annular member when sliding the switch, wherein FIG. 11a shows the switch at the close position, and FIG. 11b shows the switch at the open position.

FIG. 12a, FIG. 12b and FIG. 12c schematically illustrate the different positions of the actuator and the annular member, wherein FIG. 12a shows the actuator in the locked state, FIG. 12b shows the actuator in the unlocked state, and FIG. 12c shows the actuator in the pressed state.

In the drawings, the same reference signs refer to the same or functionally equivalent components, unless otherwise specified. The components shown in the drawings are not all drawn to scale, but are intended to clearly illustrate the principles of the invention.

### DETAILED DESCRIPTION OF THE INVENTION

Some exemplary embodiments will now be described to provide a comprehensive understanding of the principles of the structure, function, manufacture, and use of the mechanism, the assembly, the system and the method disclosed herein.

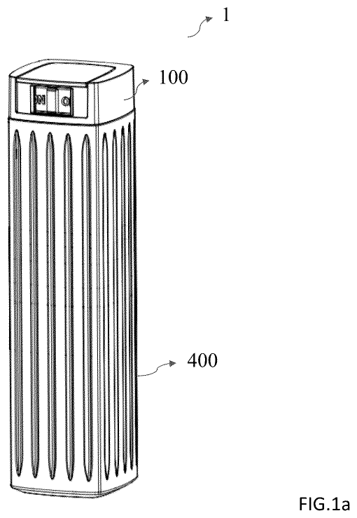

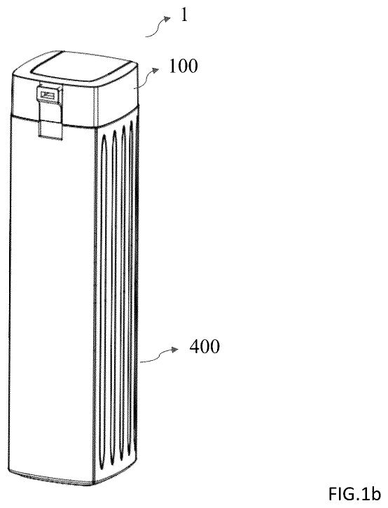

FIGS. 1a and 1b show an exemplary embodiment of the container system 1 according to the present invention. The container system 1 comprises a locking mechanism 100 located at the top of the container 400. The container 400 defines a storage chamber for containing materials. The storage chamber may store products as required, such as liquids, viscous flowable materials, foams, gels, pastes and the like. For example, materials stored in the container may include, but are not limited to, lotions, toners, essential oils, eye creams, serums, foundations, medications and other products suitable for dispensing by a dispensing pump.

The container 100 as a whole may be made of plastic such as polypropylene (PP), high density polyethylene (HDPE) or PETG material, so that all the components of the entire container system are recyclable. The container 400 may be in the form of a square-shaped container as shown in FIGS. 1a and 1b, but is not limited thereto. Similarly, in the embodiment shown, the container 400 and/or other components have a generally rectangular shape, e.g., have a square contour. But it should be understood that different shapes are possible in other variations. In one embodiment, the container 400 may include an outer container and an inner container. In another embodiment, the container 400 may also comprise only a single container. The top of the container may comprise a bayonet connection, crimp connection, snap connection, adhesive connection, or threaded connection for connecting to the dispensing pump assembly.

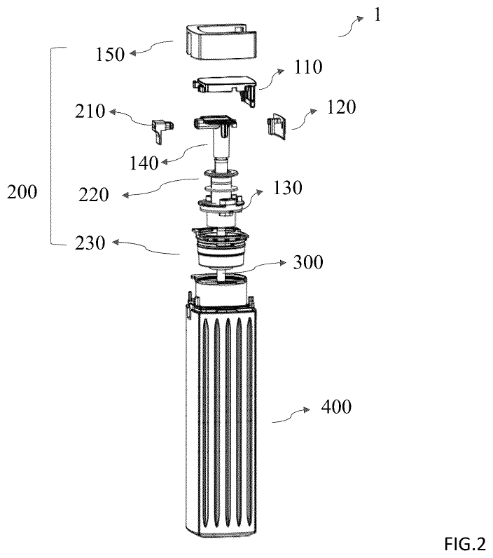

FIG. 2 is an exploded view of the components constituting the container system 1, wherein the container system 1 comprises a dispensing pump assembly 200, a tube 300 connected with the lower end of the dispensing pump and a container 400. The dispensing pump assembly 200 comprises a locking mechanism 100, a nozzle 210 for dispensing the material, a dispensing pump 200 for pumping the material and a collar 230 located outside of the dispensing pump. The dispensing pump 200 herein may be any suitable pump type for pumping the material in the container. The dispensing pump 220 may be connected with the collar 230, and the collar 230 is configured to be hermetically connected to the top of the container 400. The dispensing pump assembly 200 according to the present invention may comprise a locked state, an unlocked state and a pressed state.

The exemplary embodiment of the locking mechanism 100 generally comprises a movable button 110, a slidable switch 120, a rotatable annular member 120, an actuator 140 and an outer cover 150. The button 110 may be actuated by the user to move between an initial position and a pressed position, for example, in the vertical direction. The outer cover 150 receives the button 110 on its inside and allows the button to move vertically down along it. The outer cover 150 further comprises a nozzle guiding channel for receiving and guiding the movement of the nozzle 210. The outer cover 150 may generally have a rectangular outer contour.

The locking mechanism 100 may have a locking state that prohibits the user from actuating the button and an unlocking state that allows the user to actuate the button. When the locking mechanism is in the locking state, even if the user actuates the button, the button and the actuator could not move, so that the pump core (not shown) of the dispensing pump 220 remains in a closed state, thereby prohibiting pumping out the material. When the locking mechanism is in the unlocking state, the user actuates the button, which causes the actuator to move and open the pump core, allowing the material to be dispensed. The locking mechanism 100 as a whole may be made of plastic, such as a PP material.

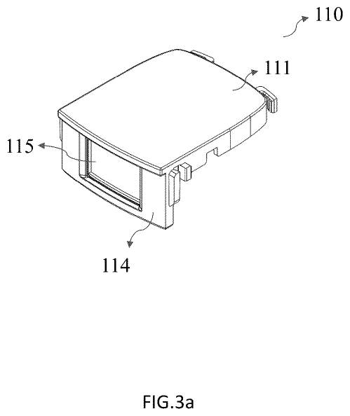

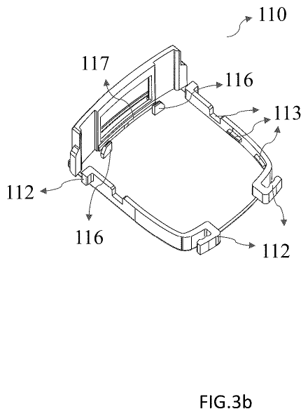

Referring to FIGS. 3a and 3b, the button 110 according to one exemplary embodiment may generally have a rectangular outer contour. The button 110 comprises a top lid 111 which may form part of the top of the container in the assembled state. The top lid 111 may generally be flat. In one embodiment, the top lid 111 has a generally rectangular shape. The button 110 may also comprise a first fastener 112 for connecting to the outer cover 150 and a second fastener 113 for connecting to the actuator 140, for example, by form fit, snap connection or the like. In the assembled state, the outer surface of the button does not exceed the outer surface of the outer cover, so that the outer cover and the button form an integral entirety. In a particular embodiment, the top lid of the button may be aligned with the top surface of the outer cover, and the top lid and the top surface of the outer cover may together constitute the top surface of the container system. The button 110 further comprises a sidewall 114 extending sideways from the top lid. A window 115 may be provided in the sidewall 114, which enables the switch to be visible to the user. A portion of the switch 120 may extend through the window 115, so that the user could touch this portion for sliding the switch.

The button 110 comprises a limit stop 116 limiting the open position and the close position of the switch. In one embodiment, as shown in FIG. 3b, the limit stop may be configured in the form of two stopping blocks standing separately on both sides. The button 110 may further include a stroke guide 117 for guiding the movement of the switch, so as to guide the switch 120 to move along a predetermined travel path. Preferably, the predetermined travel path is configured as linear. The stroke guide 117 may be configured to have a shape that substantially matches the switch. In the illustrated embodiment, the stroke guide 117 is slightly arched, but may also have other suitable shapes.

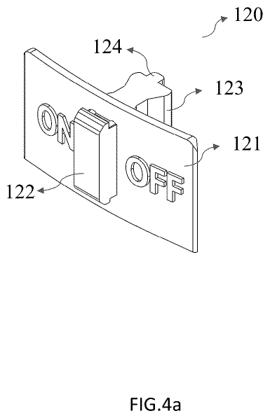

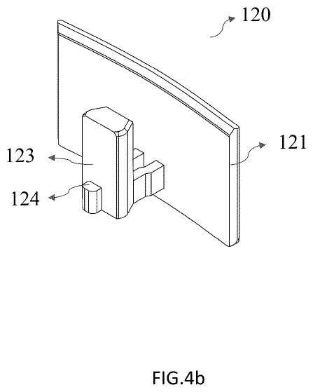

FIGS. 4a and 4b illustrate a switch 120 that may be embedded in the button 110 according to one exemplary embodiment. The switch may be recessed inward with respect to the outer cover. The switch may be located on only one side of the locking mechanism, making it easy for the user to operate with one hand or even with a single finger. The switch 120 comprises a base 121 that is generally in the form of a sheet. The outer surface of the base 121 may be provided with an “ON” or “OFF” character to indicate to the user with the position of the switch. The switch 120 further comprises a slider 122 extending outward from the base. In a preferred embodiment, the slider may be in the form of a sliding block or paddle that can be slid easily by the user. In the assembled state, the slider 122 extends through the window 115 of the button 110, but being located on the inside of the outer cover 150. The switch 120 further comprises an engaging portion 123 on the inside of the base, which is configured to engage with the annular member 130, so that the annular member can be actuated. The engaging portion 123 may be spaced apart from the base 121 with a distance, for example, by a pair of legs, so that the user can slide the switch more easily. The extension portion 124 may extend inward from the engaging portion 123 for a small distance.

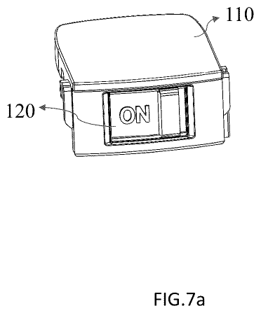

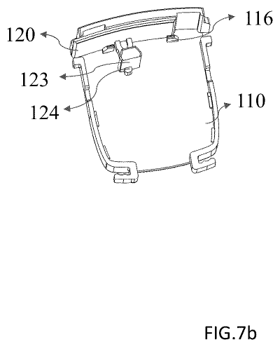

The assembly state of the button 110 and the switch 120 is best illustrated in FIGS. 7a and 7b. In an exemplary embodiment, the switch 120 may be actuated by the user to move between the open position and the close position defined by the limit stop 116. For example, the user can easily slide the switch with just one finger. By means of the characters on the switch, the user can clearly know the actual position of the switch.

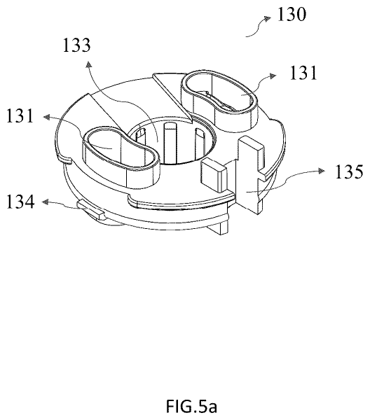

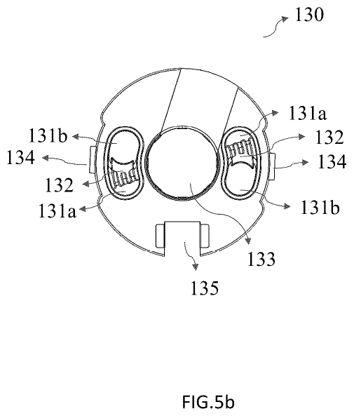

FIGS. 5a and 5b illustrate a perspective view and a top view of the annular member 130 according to an exemplary embodiment of the present application, respectively. The annular member 130 is rotatable and may be actuated by the switch, so that the sliding motion of the switch can cause the rotational motion of the annular member. When the switch is at the open position, that is, the locking mechanism is in unlocking state, the annular member 130 allows the user to actuate the button 110, so that the dispensing pump could dispense. When the switch is at the close position, that is, the locking mechanism is in the locking state, the annular member 130 prevents the movement of the button 110 to prohibit the dispensing pump from dispensing.

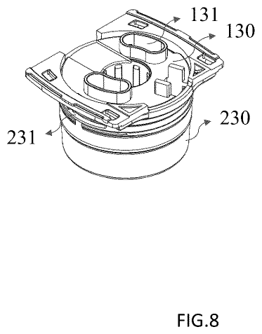

The annular member 130 generally has an annular shape, and is suitable for be assembled inside of the collar 230. The shape of the annular member 130 matches with that of the inside of the collar 230, for example, both have a generally circular shape. The assembly state of the annular member and the collar 230 is clearly shown in FIG. 8. The annular member 130 further comprises, at the center, a central through-opening 133 for the dispensing pump to pass through.

Adjacent the central through-opening 133, the annular member comprises at least one substantially arc-shaped guiding groove 131. As shown in FIG. 5b, the guiding groove 131 comprises a first end 131a and a second end 131b. The first end 131a may include a barrier 132 at the bottom to prevent the actuator from moving down, and the second end 131b is open at the bottom to allow the actuator to move down. In a preferred embodiment, the annular member 130 may include a first guiding groove and a second guiding groove disposed symmetrically. The first end and the second end of the first guiding groove may be arranged as centrally symmetrical with the first end and the second end of the second guiding groove, respectively.

The annular member 130 assembled inside the collar 230 further comprises at least one lateral flange 134 for limiting the stroke of the annular member. The lateral flange 134 extends through the lateral opening 231 of the collar 230 and is guided in this lateral opening. When actuated by the switch, the annular member rotates inside the collar and along the lateral opening 231. In a preferred embodiment, the annular member 130 comprises two lateral flanges 134 provided symmetrically, for better guiding the rotation of the annular member.

The annular member 130 further comprises a receiving portion 135 for receiving the engaging portion 123 of the switch 120. The receiving portion 135 cooperates with the engaging portion 123, such that the sliding movement of the switch causes the annular member to rotate along the lateral opening of the collar 230. For example, the receiving portion 135 and the engaging portion 123 may form an interference fit, a transition fit, a gap fit and the like. In the embodiment shown, the receiving portion 135 may also include a lateral stop extending vertically upward and/or downward from the base of the annular member, for preventing the engaging portion 123 of the switch from detaching from the receiving portion 135.

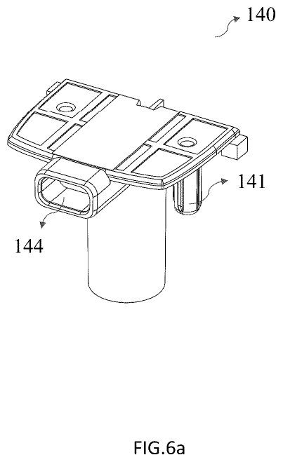

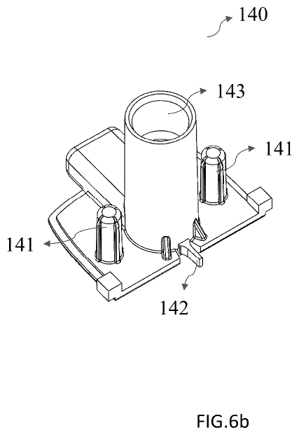

An exemplary embodiment of the actuator 140 for actuating the dispensing pump is clearly illustrated in FIGS. 6a and 6b. The actuator 140 is connected with the button 110 and is located below it. When the switch is at the open position, the user actuation of the button may cause the actuator to actuate the dispensing pump so as to dispense the material from the container. The actuator comprises at least one guiding post 141, at least part of which is received in the corresponding guiding groove 131 of the annular member. Preferably, the lower portion of the guiding post 141 is received in the guiding groove 131. The guiding post 141 is movable between the first end 131a and the second end 131b of the guiding groove 131 relative to the annular member. When the guiding post 141 is located at the first end 131a, its downward movement is prevented by the barrier 132. And when the guiding post 141 is located at the second end 131b, it is allowed to move down. In a preferred embodiment, the actuator comprises a first guiding post and a second guiding post disposed symmetrically. The first guiding post and the second guiding post are received in the corresponding first and second guiding grooves, respectively. When actuated, the first and the second guiding posts move in the same direction relative to the annular member 130. When its movement is blocked, the first and second guiding posts of the actuator can provide a firm support for the button at multiple positions, further preventing product leakage which may be caused by accidental actuation of the button.

The actuator 140 comprises a tab 142 located in the middle position. The tab extends towards the side of the switch. The tab 142 is disposed at approximately the same height as the extension portion 124 of the switch 120, and the extension portion is configured to extend inward and slightly exceed the outer end of the tab 142, for example, exceeding a short distance, such that the extension portion and the tab can be in contact in the middle position, and at the same time the extension portion can pass by the tab easily, without providing the user a feeling of excessive obstruction. As shown in FIGS. 13a and 13b, when the switch slides from left to right until the intermediate position, the tab 142 may contact the extension portion 124 of the switch. When further sliding the switch to the right such that the extension portion 124 passes by the tab 142, the extension portion 124 slightly rubs against the tab 142, providing the user a prompt that a switchover has been implemented. The prompt may be a crisp sound and/or a haptic sensation similar to gear shifting. The same applies for the switchover in the opposite direction. With such provisions, the user can clearly feel the switchover of the switch position and the change of the locking mechanism state, even without the characters on the switch. An excellent user experience is thus provided.

In addition, the actuator 140 further comprises a central channel 143 located at the center for engaging the dispensing pump 220 and a lateral channel 144 laterally located for receiving the nozzle 210, enabling the dispensing of material from the container via the dispensing pump and the nozzle.

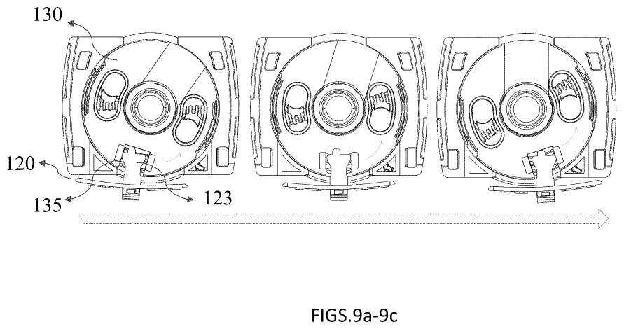

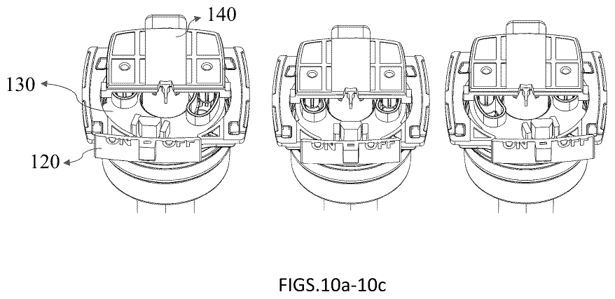

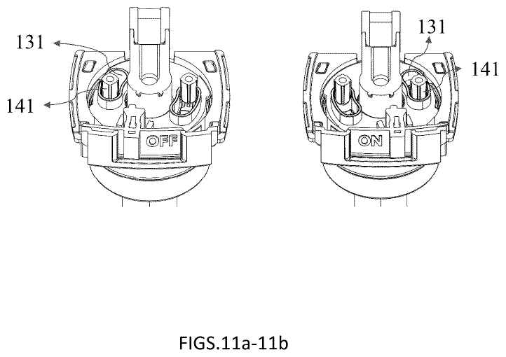

FIGS. 9a to 9c schematically illustrate the operation of the switch from the close position to the open position in a top view: FIG. 9a shows the switch at the close position, FIG. 9b shows the switch at the intermediate position, and FIG. 9c shows the switch reaching the open position. When the user slides the switch 120 in the direction indicated by the arrow; by means of the cooperation between the engaging portion 123 and the receiving portion 135, the annular member 130 located within the collar 230 is actuated to rotate in a counterclockwise direction. During this moment, the actuator 140 does not rotate, as shown in FIGS. 10a to 10c. For the purpose of clear illustration, the top of the actuator is removed in FIGS. 11a and 11b so that its guiding post 141 can be shown. Due to the rotation of the annular member 130, the guiding post 141 received in the guiding groove 131 moves from the first end 131a to the second end 131b relative to the annular member 130. When the guiding post 141 reaches the second end, the locking mechanism switches from the locking state to the unlocking state.

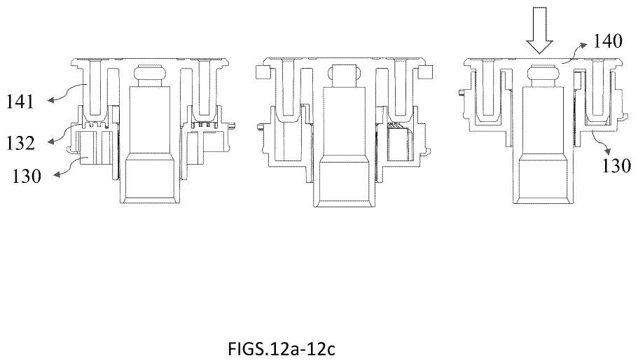

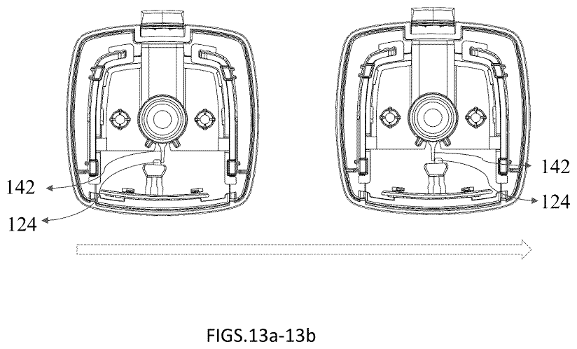

Referring to FIGS. 12a to 12c, the actuator is shown in the locked state, unlocked state and pressed state. In the locked state shown in FIG. 12a, the barrier 132 prevents the guiding post 141 of the actuator 140 from moving down. In the unlocked state shown in FIG. 12b, the guiding post reaches its second end relative to the annular member. In the pressed state shown in FIG. 12c, the button is moved down from the initial position to the pressed position by the user pressing the button in the direction indicated by the arrow in the figure. At this point, the guiding post moves down, and meanwhile the actuator actuates the dispensing pump to dispense the material from the container.

Although it is shown in the figures that the counterclockwise direction corresponds to opening, the direction is not limited to the counterclockwise direction. The directions or orientations in the embodiments of the present application may be changed as needed without departing from the scope of the present application. The terms “up”, “down”, “downward”, “left” and “right” used in the present application are for illustrative purposes only and are not limited thereto. Those skilled in the art may change the directions as needed. Although the present invention has been described in detail with reference to preferred embodiments, it will be understood that the present invention is not limited by the disclosed examples, and those skilled in the art may make many other modifications and variations based on them without departing from the scope of the present invention. It should be noted that the use of “a” and “one” throughout the present application does not exclude a plural number, and “comprise” and “include” do not exclude other components. In addition, components described in connection with different embodiments may be combined.

### LIST OF REFERENCE SIGNS

1 Container system
100 Locking mechanism
110 Button
111 Top lid
112 First fastener
113 Second fastener
114 Sidewall
115 Window
116 Limit stop
117 Stroke guide
120 Switch
121 Base
122 Slider
123 Engaging portion
124 Extension portion
130 Annular member
131 Guiding groove
131a First end
131b Second end
132 Barrier
133 Central through-opening
134 Lateral flange
135 Receiving portion
140 Actuator
141 Guiding post
142 Tab
143 Central channel
144 Lateral channel
150 Outer cover
200 Dispensing pump assembly
210 Nozzle
220 Dispensing pump
230 Collar
231 Lateral opening
300 Tube
400 Container

1. A locking mechanism for a dispensing pump, comprising:
a movable button actuatable by a user to move between an initial position and a pressed position;
a slidable switch embedded in the button, the switch being actuatable by the user to move between an open position and a close position, such that the locking mechanism changes between an unlocking state and a locking state;
a rotatable annular member cooperating with the switch, which can be actuated by the switch such that a sliding movement of the switch causes rotation of the annular member, wherein:
when the locking mechanism is in the unlocking state, the annular member allows the user to actuate the button so as to enable a dispensing; and
when the locking mechanism is in the locking state, the annular member prevents the movement of the button so as to prohibit the dispensing.

2. The locking mechanism according to claim 1, wherein the locking mechanism further comprises an actuator located below the button for actuating the dispensing pump, the actuator being connected with the button and actuated by the button, wherein the actuator comprises at least one guiding post, at least a portion of which is received in a corresponding guiding groove of the annular member, and the guiding post is movable between a first end and a second end of the guiding groove relative to the annular member.

3. The locking mechanism according to claim 2, wherein:
when the locking mechanism is in the locking state, the guiding post is located at the first end of the guiding groove which prevents the guiding post from moving down; and
when the locking mechanism is in the unlocking state, the guiding post is located at the second end of the guiding groove which allows the guiding post to move down.

4. The locking mechanism according to claim 3, wherein the first end of the guiding groove comprises a barrier at the bottom to prevent the guiding post from moving down, and the second end of the guiding groove is open at the bottom to allow the guiding post to move down.

5. The locking mechanism according to claim 2, wherein the actuator comprises a first guiding post and a second guiding post; the annular member comprises a first guiding groove and a second guiding groove receiving the first guiding post and the second guiding post, respectively; when the annular member is actuated, the first guiding post and the second guiding post move in the same direction with respect to the annular member.

6. The locking mechanism according to claim 2, wherein the switch comprises:
a base;
a slider extending outward from the base; and
an engaging portion located on the inside of the base, which is configured to engage with the annular member so as to actuate the annular member.

7. The locking mechanism according to claim 6, wherein the switch further comprises an extension portion extending inward from the engaging portion, and when the switch is in an intermediate position, the extension portion is configured to extend inward and slightly exceed an outer end of a tab of the actuator, such that when the extension portion passes the tab upon sliding the switch, it rubs slightly against the tab, thereby producing a crisp sound and/or providing the user with a tactile prompt that a switchover has been implemented.

8. The locking mechanism according to claim 6, wherein the switch is located on only one side of the locking mechanism.

9. The locking mechanism according to claim 2, wherein the annular member comprises:
a central through-opening, through which the dispensing pump passes;
at least one lateral flange configured to limit the stroke of the annular member; and
a receiving portion configured to receive the engaging portion of the switch and to cooperate with it, such that a sliding motion of the switch is converted into a rotational motion of the annular member.

10. The locking mechanism according to claim 2, wherein the button further comprises:
a top lid;
a first fastener configured to fix the button to an outer cover;
a second fastener configured to fix the button to the actuator;
a sidewall comprising a window enabling the switch to be visible to the user and through which the slider of the switch extends such that the slider is accessible to the user;
a limit stop configured to limit the open position and Close position of the switch; and/or
a stroke guide for guiding the movement of the switch such that the switch moves along a predetermined travel path.

11. The locking mechanism according to claim 2, wherein the actuator further comprises:
a central channel for receiving the dispensing pump, inside of which comprises a connector in fluid communication with the dispensing pump; and
a lateral channel for receiving a nozzle so as to enable the dispensing by means of the dispending pump via the nozzle when the actuator moves down.

12. The locking mechanism according to claim 1, wherein the locking mechanism further comprises an outer cover which receives the button on the inside and allows the button to move down, the outer cover further comprising a nozzle guiding channel for receiving and guiding the movement of the nozzle.

13. The locking mechanism according to claim 12, wherein an outer surface of the switch and/or the button do not exceed an outer surface of the outer cover.

14. The locking mechanism according to claim 12, wherein the outer cover and/or the button have a rectangular outer contour.

15. A dispensing pump assembly, comprising:
the locking mechanism according to claim 1;
a nozzle for dispensing a material;
a dispensing pump for pumping the material, which is connected to the actuator; and
a collar connected with the dispensing pump and located outside of the dispensing pump, which is also connected to the outer cover and the container, and the collar further comprises at least one lateral opening which limits the stroke of a lateral flange of the annular member.

16. A container system comprising:
the dispensing pump assembly according to claim 15;
a tube connected with a lower end of the dispensing pump; and
a container which defines a storage chamber for containing a material, the container being hermetically connected with the dispensing pump assembly at the top circumference, wherein the tube extends into the container, and when the switch is at the open position, pressing the button allows the material to be dispensed from the container.

17. The container system according to claim 16, wherein the container has a rectangular outer contour.

18. A method for using the container system according to claim 16, comprising:
sliding the switch from a close position to an open position such that the locking mechanism switches from a locking state to an unlocking state, and at the same time, the guiding post of the actuator moves from the first end of the guiding groove to its second end relative to the annular member; and
pressing the button to move it down from an initial position to a pressed position such that the actuator is caused to actuate the dispensing pump to dispense the material from the container via the nozzle.

19. The method according to claim 18, wherein when an intermediate position is passed by upon sliding the switch, the extension portion of the switch passes by and slightly rubs against the tab of the actuator, thereby producing a crisp sound and/or providing the user with a tactile prompt that a switchover has been implemented.
